(19) United States
(12) Patent Application Publication
(10) Pub. No.: US 2026/0367347 A1
(43) Pub. Date: Nov. 19, 2026

(54) CO-PACKAGED OPTICS DEVICE AND OPTO-ELECTRONIC MODULE

(71) Applicant: Taiwan Semiconductor Manufacturing Company, Ltd., Hsinchu (TW)

(72) Inventors: Hsuan-Ting Kuo, Taichung City (TW); Chao-Wei Chiu, Hsinchu City (TW); Chia-Shen Cheng, Hsinchu County (TW); Wen-Chih Lin, Hsinchu (TW); Yen-Hung Chen, Hsinchu City (TW); Cheng-Yu Kuo, Kaohsiung City (TW); Hsiu-Jen Lin, Hsinchu County (TW); Ching-Hua Hsieh, Hsinchu (TW)

(73) Assignee: Taiwan Semiconductor Manufacturing Company, Ltd., Hsinchu (TW)

(21) Appl. No.: 19/754,262

(22) Filed: Jul. 26, 2026

Related U.S. Application Data
(62) Division of application No. 18/522,224, filed on Nov. 29, 2023.

(51) Int. Cl. G02B 6/43; G02B 6/42

(52) U.S. Cl. CPC G02B 6/43; G02B 6/4213; G02B 6/428

(57) ABSTRACT

An opto-electronic module and a co-packaged optics device included therein are provided. The co-packaged optics device can include a package substrate; an electronic component disposed on the package substrate; optical transceivers disposed on the package substrate, arranged around the electronic component, wherein the electronic component is electrically connected to the optical transceivers; and a waveguide component disposed on the package substrate. The waveguide component includes a waveguide bulk having an inward surface facing the optical transceivers and an outward surface opposite to the inward surface; a first waveguide channel embedded in the waveguide bulk and extending from the outward surface to the inward surface; and a second waveguide channel embedded in the waveguide bulk and extending from the outward surface to the inward surface, wherein the first waveguide channel and the second waveguide channel are intersected and directed to different ones of the optical transceivers.

### CROSS-REFERENCE TO RELATED APPLICATION

This application is a divisional application of and claims the priority benefit of an application Ser. No. 18/522,224, filed on Nov. 29, 2023. The entirety of each of the above-mentioned patent applications is hereby incorporated by reference herein and made a part of this specification.

### BACKGROUND

In terms of IC evolution, functional density (i.e., the number of interconnected devices per chip area) has generally increased while geometry size (i.e., the smallest component (or line) that can be created using a fabrication process) has decreased. This scaling down process generally provides benefits by increasing production efficiency and lowering associated costs. Such scaling down has also increased the complexity of IC processing and manufacturing, and for these advancements to be realized, similar developments in package processing and manufacturing are needed. For example, co-packaged optics integrating the electrical and optical components is developed to enable higher capacities (e.g., smaller footprint) with lower power consumption and increased data speeds.

### BRIEF DESCRIPTION OF THE DRAWINGS

FIG. 1 schematically illustrates an opto-electronic module in accordance with some embodiments of the disclosure.

FIG. 2 schematically illustrates a cross-sectional view of a co-packaged optics device with the fiber array units attached thereto in accordance with some embodiments of the disclosure.

FIG. 3 to FIG. 6 schematically illustrate a fabrication process of a waveguide channel in accordance with some embodiments of the disclosure.

FIG. 7 schematically illustrates a fabrication process of a waveguide channel in accordance with some embodiments of the disclosure.

FIG. 8A to FIG. 8C schematically illustrate cross-sectional views of several waveguide channel in accordance with some embodiments of the disclosure.

FIG. 9 schematically illustrates a cross-sectional view of a co-packaged optics device with the fiber array units attached thereto in accordance with some embodiments of the disclosure.

FIG. 10 to FIG. 13 schematically illustrate a fabrication process of a fiber array unit in accordance with some embodiments of the disclosure.

FIG. 14 and FIG. 15 schematically illustrate various optical fibers in accordance with some embodiments of the disclosure.

### DESCRIPTION OF THE EMBODIMENTS

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows can include embodiments in which the first and second features are formed in direct contact, and can also include embodiments in which additional features can be formed between the first and second features, such that the first and second features can not be in direct contact. In addition, the present disclosure can repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, can be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein can likewise be interpreted accordingly.

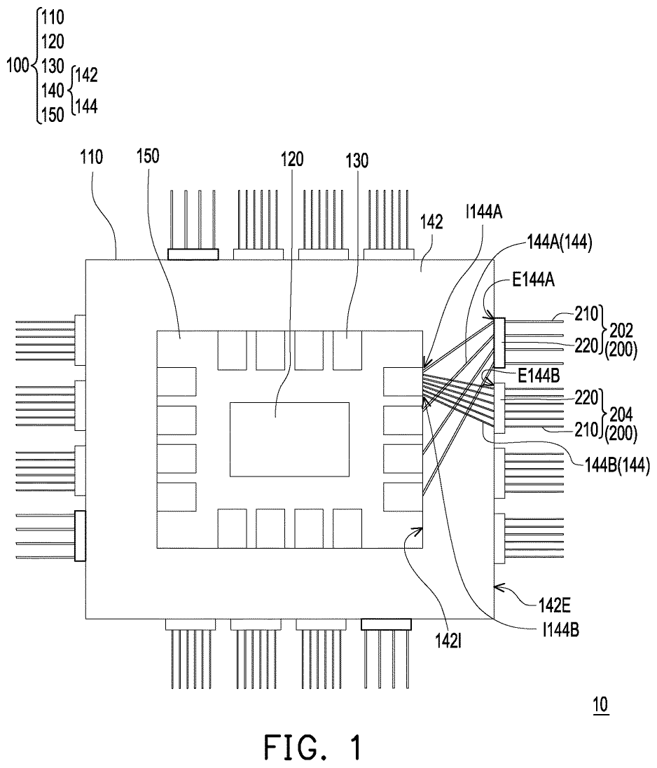

FIG. 1 schematically illustrates an opto-electronic module in accordance with some embodiments of the disclosure. The opto-electronic module 10 can at least include a co-packaged optic device 100, and fiber array units 200. In some embodiments, the fiber array units 200 are attached to the co-packaged optics device 100, optionally, in a detachable way. In some embodiments, the co-packaged optics device 100 integrate optical components and electronic component in one package, which increases the interconnecting bandwidth density and energy efficiency by shortening the electrical link length through the packaging and co-optimization of electronics and photonics.

Each of the fiber array unit 200 includes multiple optical fibers 210 that are assembled by an optical connector 220. In some embodiments, the first fiber array unit 202 of the fiber array units 200 can connect to an external laser source to transmit power and the second fiber array unit 204 of the fiber array units 200 can connect to an external device to transmit data signals between the external device and the co-packaged optics device 100. In some embodiments, a quantity of the fiber array units 200 for transmitting data signals, e.g. the second fiber array units 204, is greater than a quantity of the fiber array units 200 for transmitting power, e.g. the first fiber array units 202. For example, the co-packaged optics device 100 in FIG. 1 has a rectangular shape in the top view and each side of the co-packaged optics device 100 is attached with four fiber array units 200 including one first fiber array unit 202 and three second fiber array units 204, but the disclosure is not limited thereto. In some embodiments, the optical fibers 210 assembled in each of the fiber array units 200 have the same configuration. For example, the optical fibers 210 assembled in the first fiber array units 202 are polarization-maintaining optical fibers and the optical fibers 210 assembled in the second fiber array units 204 are single mode fibers, but the disclosure is not limited thereto.

The co-packaged optics device 100, for example, includes a package substrate 110, an electronic component 120, optical transceivers 130 and a waveguide component 140. The electronic component 120, the optical transceivers 130 and the waveguide component 140 are disposed and/or stacked on the package substrate 110. In some embodiments, the co-packaged optics device 100 can further include an interposer substrate 150. The electronic component 120 and the optical transceivers 130 are disposed on and carried by the interposer substrate 110 and the interposer substrate 150 is bonded to the package substrate 110. Accordingly, the interposer substrate 150 is located between the package substrate 110 and the electronic component 120. FIG. 1 presents the top view of the co-packaged optics device 100 and the package substrate 110 can be covered/shielded by other components so that the indication line of the package substrate 110 direct to the edge of the co-packaged optics device 100.

In some embodiments, the electronic component 120 can be a switch die such as a switch ASIC (Application-Specific Integrated Circuit) die and the optical transceivers 130 are arranged around the electronic component 120. Each of the optical transceivers 130 includes an optical-electrical converter for converting between optical signals and electrical signals and serves as an optical engine. The electronic component 120 is electrically connected to the optical transceivers 130. Each of the optical transceivers 130 can receive optical signals from external devices and converts the optical signals into electric signals that are transmitted to the electronic component 120. Each of the optical transceivers 130 can receive electric signals from the electronic component 120 and converts the electric signals into optical signals that are transmitted to external devices through the fiber array unit 200. In some embodiments, the optical transceivers 130 can be implemented as a semiconductor die, such as a photonic IC die, bonded on the interposer substrate 150.

The waveguide component 140 is an optical component that directs the transmission of the optical signals. In some embodiments, the waveguide component 140 includes a waveguide bulk 142 embedded with waveguide channels 144 therein. In some embodiments, a material of the waveguide bulk 142 is a transparent material such as glass, but the disclosure is not limited thereto. The waveguide bulk 142 of the waveguide component 140 has a shape that surrounds the optical transceivers 130. The waveguide bulk 142 of the waveguide component 140 can extend along the periphery of the interposer substrate 150 to have a ring-like shape in the top view and the optical transceivers 130 are located within a region surrounded by the waveguide component 140. In some embodiments, the interposer substrate 150 has a rectangular shape and the waveguide bulk 142 of the waveguide component 140 is formed to extend along sides of the interposer substrate 150. In some embodiments, the waveguide bulk 142 can include segments that separate from each other and respectively extend along different sides of the interposer substrate 150.

The waveguide bulk 142 of the waveguide component 140 has an inward surface 142I and an outward surface 142E. The inward surface 142I faces the optical transceivers 130 and the outward surface 142E is opposite to the inward surface 142I. The waveguide bulk 142 constructs the structure shape of the waveguide component 140 so that the inward surface 142I and the outward surface 142E can also serve as the surfaces of the waveguide component 140 and define the outline of the waveguide component 140. The waveguide channels 144 are formed in the waveguide bulk 142 to provide respective transmission paths for optical signals. Each of the waveguide channel 144 continuously extends from the inward surface 142I to the outward surface 142E. The terminals of each waveguide channel 144 respectively reach the inward surface 142I and the outward surface 142E. The fiber array units 200 are attached to the waveguide component 140 and mechanically mate the outward surface 142E according to the configuration of the waveguide channels 144. For example, the fiber array units 200 are attached to the waveguide component 140 for each of the optical fibers 210 being aligned with one of the waveguide channels 144.

For descriptive purpose, FIG. 1 omits a portion of the waveguide channels 144 embedded in the waveguide bulk 142. Specifically, FIG. 1 only presents the waveguide channels 144 for two of the fiber array units 200 (i.e. one first fiber array unit 202 and one second fiber array unit 204). In some embodiments, the waveguide channels 144 includes first waveguide channels 144A and second waveguide channels 144B. The first waveguide channels 144A provides the optical transmission paths for the first fiber array unit 202 and the second waveguide channels 144B provides the optical transmission paths for the second fiber array unit 204. In some embodiments, at least one of the optical fibers 210 of the first fiber array unit 202 and at least one of the optical fibers 210 of the second fiber array unit 204 communicate to a same one of the optical transceivers 130 through the waveguide component 140. In some embodiments, the first waveguide channels 144A establish the optical transmission paths from the first fiber array unit 202 to multiple ones of the optical transceivers 130 and the second waveguide channels 144B establish the optical transmission paths from the second fiber array unit 204 to one of the optical transceivers 130, but the disclosure is not limited thereto. In some embodiments, the first waveguide channels 144A establish the optical transmission paths from the first fiber array unit 202 to multiple ones of the optical transceivers 130 and the second waveguide channels 144B also establish the optical transmission paths from the second fiber array unit 204 to multiple ones of the optical transceivers 130. In the embodiment, two of the waveguide channels 144 are intersected and direct to different ones of the optical transceivers 130. For example, at least one of the first waveguide channels 144A and at least one of the second waveguide channels 144B are intersected and direct to different optical transceivers 130. In some embodiments, two interested waveguide channels 144 can be coincident with each other at the intersection while the signal transmitted in the two interested waveguide channels 144 are independent from each other without an interference.

In some embodiments, each of the first waveguide channels 144A has an inward end I144A reaching the inward surface 142I and an outward end E144A reaching the outward surface 142E and similarly, each of the second waveguide channels 144B has an inward end I144B reaching the inward surface 142I and an outward end E144B reaching the outward surface 142E. In some embodiments, the outward ends E144A of the first waveguide channels 144A are arranged at the same side of the outward ends E144B of the second waveguide channels 144B, and one or more of the inward ends I144B of the second waveguide channels 144B is located between two of the inward ends I142A of the first waveguide channels 144A. Therefore, the inward ends (I144A and I144B) of the waveguide channels 144 directing to the optical transceivers 130 and outward ends (E144A and E144B) of the waveguide channels 144 opposite to the inward ends (I144A and I144B) are arranged in different sequences.

The waveguide channels 144 have a refractive index greater than the waveguide bulk 142. The light entering the waveguide channels 144 can travel in the waveguide channels 144 and the light travelling in the waveguide channels 144 can be reflected at the boundary of the waveguide channels 144 rather than being refracted to enter the waveguide bulk 142. Namely, the light entering the waveguide channels 144 can be limited inside the waveguide channel 144 and travel along the path defined by the waveguide channel 144. In some embodiments, the waveguide channels 144 is of the same material as the waveguide bulk 142 but the crystalline degree of the waveguide channels 144 is different from the waveguide bulk 142 to achieve the required refractive index. In some embodiments, the waveguide channels 144 includes the same material as the waveguide bulk 142 and further includes implanted materials so that the refractive index of the waveguide channels 144 is greater than the waveguide bulk 142.

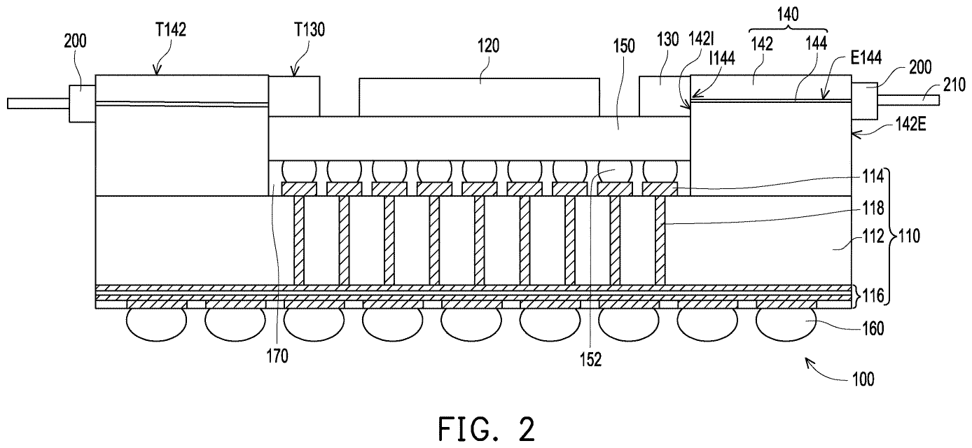

FIG. 2 schematically illustrates a cross-sectional view of a co-packaged optics device with the fiber array units attached thereto in accordance with some embodiments of the disclosure. The co-packaged optics device 100 in FIG. 2 includes a package substrate 110, an electronic component 120, optical transceivers 130, a waveguide component 140 and an interposer substrate 150. In some embodiments, the same reference numbers depicted in FIGS. 1 and 2 can refer to the same component or similar components that provide similar functions so that the descriptions for the component denoted by the same reference number in different embodiments can be incorporated into each other.

As shown in FIG. 2, the package substrate 110 includes substrate board 112, contact pads 114, a redistribution circuit structure 116 and through substrate vias 118. The contact pads 114 and the redistribution circuit structure 116 are disposed on opposite sides of the substrate board 112. The through substrate vias 118 are formed in the substrate board 112 and extend between the contact pads 112 and the redistribution circuit structure 116. The through substrate vias 118 provides electric connection paths between the contact pads 112 and the redistribution circuit structure 116. The redistribution circuit structure 116 includes one or more conductive wiring layers and one or more dielectric layers to establish the required electric transmission paths. In addition, the co-packaged optics device 100 further includes conductor connectors 160 disposed on the redistribution circuit structure 116 for connecting to an external system.

The electronic component 120 and the optical transceivers 130 are disposed on the interposer substrate 150 and the interposer substrate 150 is bonded onto the package substrate 110 through bonding components 152. The bonding components 152 are disposed between the contact pads 114 and the interposer substrate 150. In some embodiments, the bonding components 152 can be flip chip bumps such as C4 bumps, but the disclosure is not limited thereto. In some embodiments, the co-packaged optics device 100 can further include an underfill material 170 encapsulating the bonding components 152 under the interposer substrate 150. The interposer substrate 150 can include a redistribution circuit structure and through substrate vias though the drawings of FIG. 2 does not present these components. The redistribution circuit structure of the interposer substrate 150 can provide suitable electric transmission paths to electrically connect to the electronic component 120 and to the optical transceivers 130. In some embodiments, the electronic component 120 and the optical transceivers 130 are electrically connected through the redistribution circuit structure of the interposer substrate 150, but the disclosure is not limited thereto. The through substrate vias of the interposer substrate 150 can also form the electric transmission paths between the redistribution circuit structure of the interposer substrate 150 and the bonding components 152. In some embodiments the interposer substrate 150 can be a silicon substrate with the required components thereon, but the disclosure is not limited thereto.

The waveguide component 140 is disposed on the package substrate 110. In some embodiments, the waveguide component 140 is adhered onto the package substrate 110. The waveguide component 140 includes a waveguide bulk 142 and waveguide channels 144 embedded in the waveguide bulk 142. The waveguide bulk 142 has an inward surface 142I facing the optical transceivers 130 and an outward surface E142 opposite to the inward surface 142I. Each of the waveguide channels 144 has an inward end I144 reaching the inward surface 142I and an outward end E144 reaching the outward surface 142E. The waveguide bulk 142 is a transparent bulk and is, for example, of the material of glass. The waveguide bulk 142 has sufficient thickness so that the inward ends I144 of the waveguide channels 144 direct to and are aligned to the receiving structures (not shown) of the optical transceivers 130. In some embodiments, the waveguide bulk 142 can have a thickness that the top surface T142 of the waveguide bulk 142 is at a level proximate to the top surface T130 of the optical transceivers 130, but the disclosure is not limited thereto.

In some embodiments, the inward surface 142I can contact the optical transceivers 130. In some embodiments, the inward surface 142I can be attached to the optical transceivers 130 through an optical clear media such as an optical clear glue or the like. The fiber array unit 200 can be attached to the waveguide bulk 142 through an optical clear media such as an optical clear glue. In some embodiments, the fiber array unit 200 can be attached to the waveguide bulk 142 through a mechanical connection mechanism such as a pair of pins and holes on respective components, a pair of hook and groove on respective components, or the like. In some embodiments, the fiber array units 200 including the first fiber array unit 202 and the second fiber array unit 204 are mechanically detachable from the waveguide component 140. The fiber array unit 200 can be attached to the waveguide bulk 142 in a manner that one optical fiber 210 directs to and is aligned to the outward end E144 of one waveguide channel 144.

In some embodiments, the waveguide channel 144 can be arranged at a common level so that the waveguide channel 144 can be parallel to the plane of the package substrate 110 and the inward end I144 of the waveguide channel 144 can be located at the same level with the outward end E144 of the waveguide channel 144. In some embodiments, the waveguide channel 144 can be arranged obliquely with respect to the plane of the package substrate 110 and the inward end I144 of the waveguide channel 144 can be located at a level different from the outward end E144 of the waveguide channel 144. In some embodiments, two of the waveguide channels 144 are positioned at different levels above the package substrate 110. In some embodiments, the waveguide channels 144 can be arranged at shallow depth regions of the waveguide bulk 142 and the inward end I144 of the waveguide channel 144 and the outward end E144 of the waveguide channel 144 are proximate to the top surface T142 of the waveguide bulk 142. For example, the cross-section structure of the waveguide channels 144 can extend from the top surface T142 of the waveguide bulk 142 toward a certain depth inside the waveguide bulk 142. The waveguide channels 144 have a greater refractive index than the waveguide bulk 142 and can be distinguished from the waveguide bulk 142 through an optical measure technique.

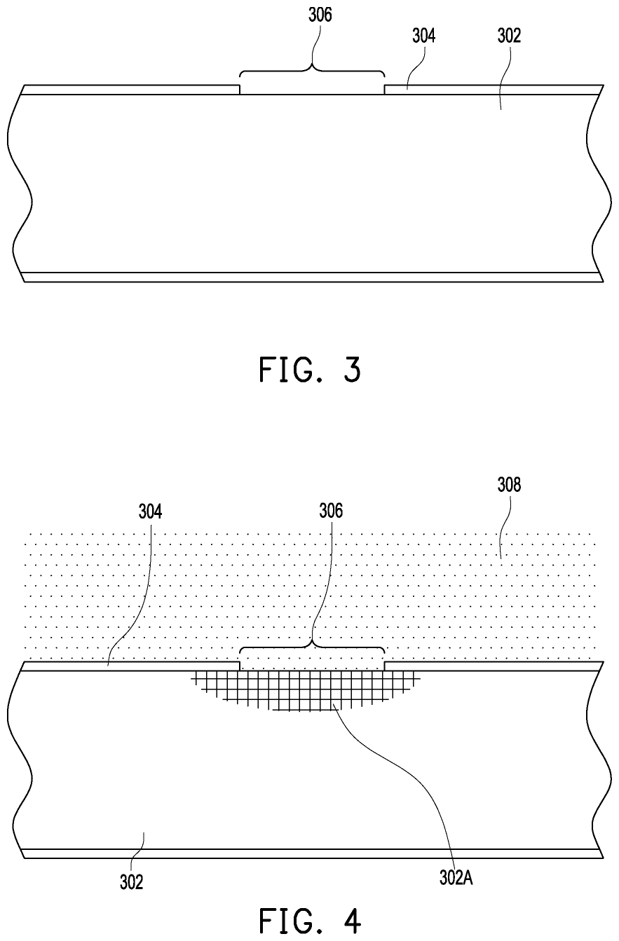

FIG. 3 to FIG. 6 schematically illustrate a fabrication process of a waveguide channel in accordance with some embodiments of the disclosure. In FIG. 3, a raw substrate 302 is provided and a mask layer 304 is formed on the outer surface of the raw substrate 302. The mask layer 304 has one or more openings 306 exposing a portion of the outer surface of the raw substrate 302 and covers the rest portions of the outer surface of the raw substrate 302. In some embodiments, the raw substrate 302 is a glass substrate or other light transparent substrates. In some embodiments, a material of the mask layer 304 can be Al, Ti, other metal material or a combination thereof. and the opening 306 can be formed by adopting a lithography and etching process.

In FIG. 4, the raw substrate 302 covered by the mask layer 304 is in contact with a first ion-exchange solution 308. In some embodiments, the first ion-exchange solution 308 is a solution of a first salt material such as AgNO₃. In some embodiments, the ion exchange between silver ions in the first ion-exchange solution 308 and sodium ions from the raw substrate 302 takes place at the outer surface of the raw substrate 302 exposed by the opening 306. A modified region 302A is formed through the ion exchange process and the modified region 302A is distributed from the surface of the raw substrate 302 exposed by the opening 306 into a certain depth (e.g. several micrometers) of the raw substrate 302.

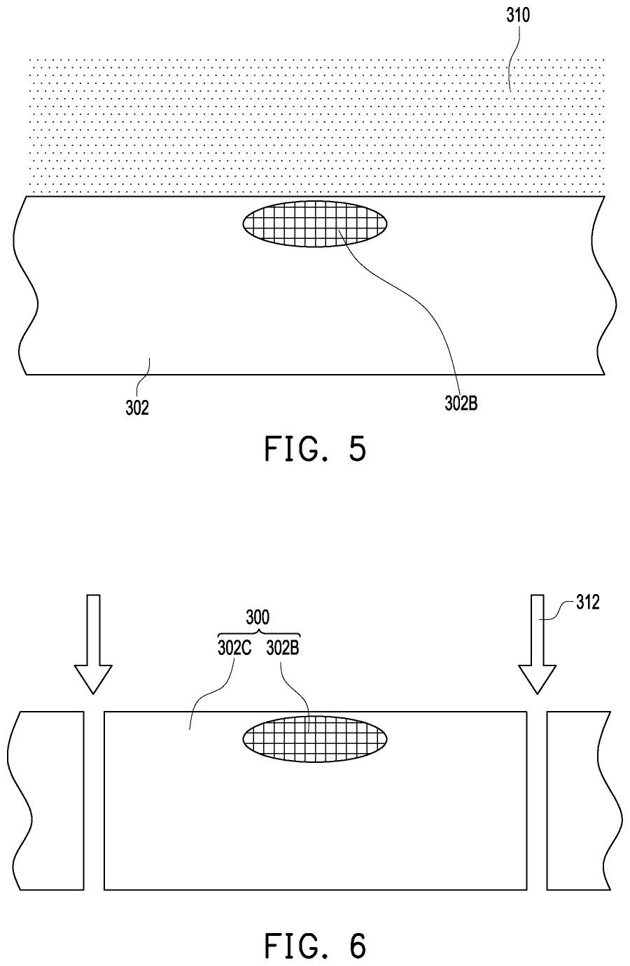

In FIG. 5, the mask layer 304 covering the raw substrate 302 is removed and the raw substrate 302 is in contact with a second ion-exchange solution 310. In some embodiments, the second ion-exchange solution 310 is a solution of a second salt material such as NaNO₃. By contacting the raw substrate 302 with the second ion-exchange solution 310, the silver ions near the surface are replaced with sodium ions and diffused into deeper depth of the raw substrate 302. A waveguide channel 302B is then formed through the ion exchange process of the second ion-exchange solution 310. In some embodiments, the waveguide channel 302B can include a core containing silver and a cladding layer containing sodium and wrapping the core. In FIG. 6, the raw substrate 302 is cut to have a required shape by using a cutter such as a laser cutter or the like to obtain a waveguide component 300 including a waveguide bulk 302C and the wave guide channel 302B embedded therein. The waveguide bulk 302C is cut from the raw substrate 302 and can be of the material of glass. The waveguide component 300 can be an implemental example for the waveguide component 140 described in the previous and other waveguide component described in the following embodiments.

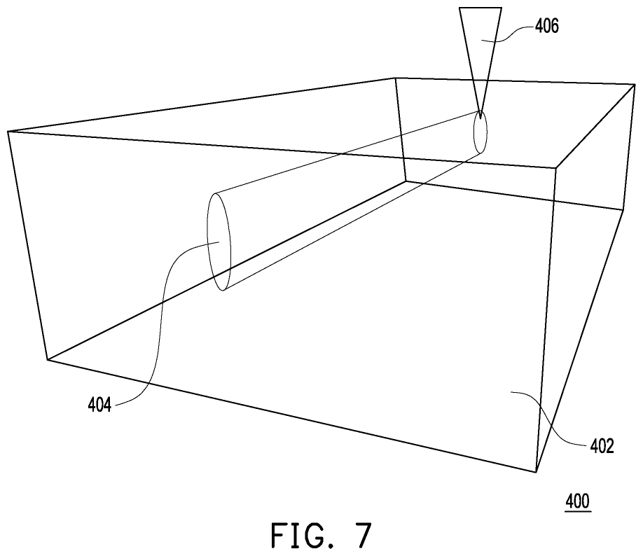

FIG. 7 schematically illustrates a fabrication process of a waveguide channel in accordance with some embodiments of the disclosure. As shown in FIG. 7, a waveguide component 400 including a waveguide bulk 402 and a waveguide channel 404 embedded therein is fabricated by irradiating a laser beam 406 to a predetermined depth of the waveguide bulk 402 along a predetermined path. In some embodiments, the irradiation of the laser beam 404 causes the material of the waveguide bulk 402 to crystallize to form the waveguide channel 404 that has a refractive index greater than the rest portion (for example, the non-irradiated portion) of the waveguide bulk 402. The crystalline degree of the waveguide channel 404 is greater than the waveguide bulk 402. The waveguide component 400 can be an implemental example for the waveguide component 140 described in the previous and other waveguide component described in the following embodiments.

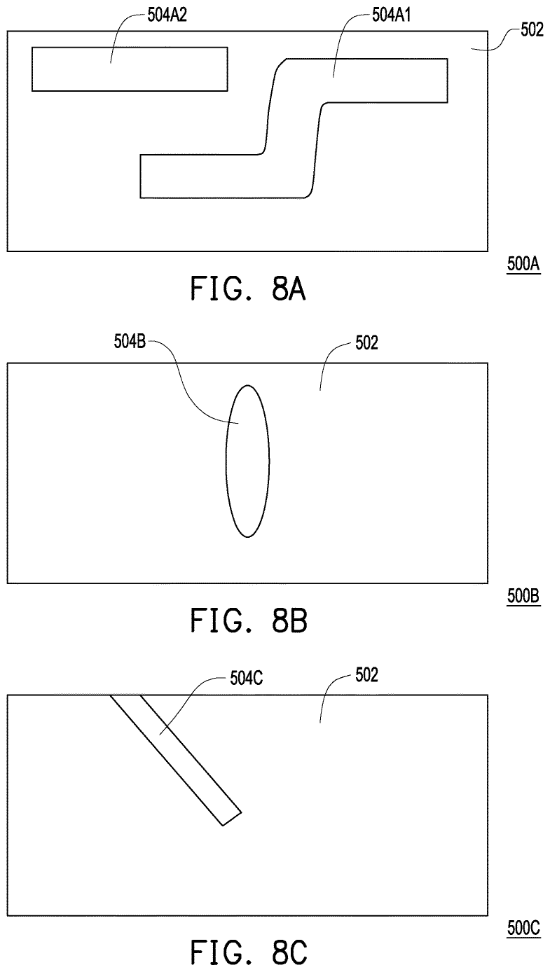

FIG. 8A to FIG. 8C schematically illustrate cross-sectional views of several waveguide channel in accordance with some embodiments of the disclosure. In FIG. 8A, a waveguide component 500A includes a waveguide bulk 502 and waveguide channels 504A1 and 504A2 embedded therein. The cross-sectional structure of the waveguide channel 504A1 can include a bended pattern and the cross-sectional structure of the waveguide channel 504A2 can include a linear pattern extending at a common level. In FIG. 8B, a waveguide component 500B includes a waveguide bulk 502 and a waveguide channel 504B embedded therein. The cross-sectional structure of the waveguide channel 504B can include an oval (or circular) pattern. In FIG. 8C, a waveguide component 500C includes a waveguide bulk 502 and a waveguide channel 504C embedded therein. The cross-sectional structure of the waveguide channel 504C can include an oblique pattern extending from the top surface of the waveguide bulk 502 into a certain depth along an oblique direction. In some embodiments, the waveguide channels 504A1, 504A2, 504B and 504C can be fabricated by using the process described in FIG. 7. The structural pattern of the waveguide channels 504A1, 504A2, 504B and 504C can be determined by setting the irradiation depth, the moving path or the like of the laser bean 406. The structural pattern shown in FIGS. 8A to 8C are exemplary examples and are not intended to serve as the limitation of the disclosure.

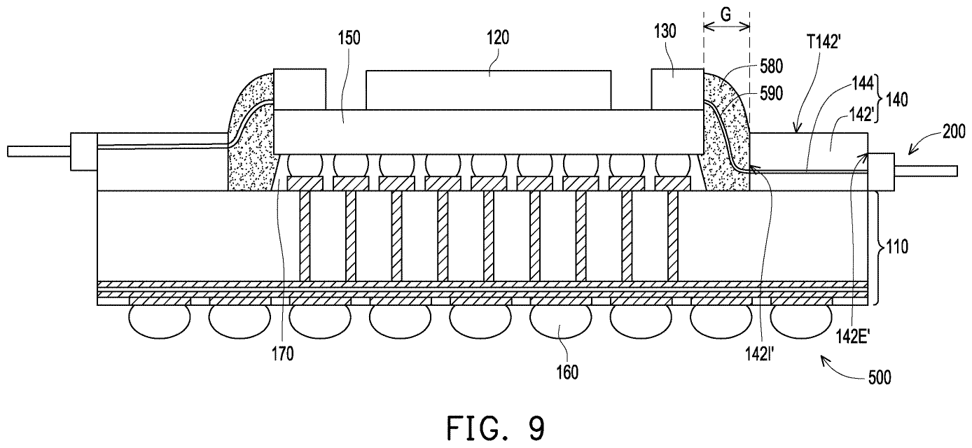

FIG. 9 schematically illustrates a cross-sectional view of a co-packaged optics device with the fiber array units attached thereto in accordance with some embodiments of the disclosure. The co-packaged optics device 500 in FIG. 9 includes a package substrate 110, an electronic component 120, optical transceivers 130, a waveguide component 140, an interposer substrate 150, conductor connectors 160, an underfill material 170, a gap fill material 580 and an intermediate waveguide channel 590. In some embodiments, the same reference numbers depicted in FIGS. 1, 2 and 9 can refer to the same component or similar components that provide similar functions so that the descriptions for the component denoted by the same reference number in different embodiments can be incorporated into each other. Specifically, the descriptions of the package substrate 110, the electronic component 120, the optical transceivers 130, the waveguide component 140, the interposer substrate 150, the conductor connectors 160, and the underfill material 170 can refer to the embodiments of FIG. 1 and FIG. 2, and not be reiterated herein.

The waveguide component 140 of the co-packaged optics device 500 can have a different size design than the waveguide component 140 described in FIG. 1 or FIG. 2. The waveguide component 140 in FIG. 9 includes a waveguide bulk 142′ and waveguide channels 144 embedded therein. The waveguide bulk 142′ is spaced from the optical transceivers 130 by a gap G and the top surface T142′ of the waveguide bulk 142′ can be lower than the optical transceivers 130. The waveguide bulk 142′ has an inward surface 142I′ facing the optical transceivers 130 and an outward surface 142E′ opposite to the inward surface 142I′. Each of the waveguide channels 144 extends from the inward surface 142I′ to the outward surface 142E′ and does not straightly align to the receiving structures (not shown) of the corresponding optical transceiver 130.

The gap fill material 580 is disposed between the optical transceivers 130 and the waveguide bulk 142′ and the intermediate waveguide channel 590 extends between one of the waveguide channels 144 and one of the optical transceivers 130. The intermediate waveguide channel 590 is surrounded and encapsulated by the gap fill material 580. The gap fill material 580 fills the gap G and protects the intermediate waveguide channel 590. The intermediate waveguide channel 590 establishes the optical signal transmission path between the waveguide channel 144 and the corresponding optical transceiver 130. The intermediate waveguide channel 590 can be a polymer waveguide channel. In some embodiments, the intermediate waveguide channel 590 is fabricated by disposing a photo-sensitive material at the gap G, irradiating the photo-sensitive material by a laser beam along predetermined path to form the intermediate waveguide channel 590, and removing the other portions of the photo-sensitive material. The gap fill material 580 can be formed after the formation of the intermediate waveguide channel 590 to encapsulate the intermediate waveguide channel 590. In some embodiments, the intermediate waveguide channel 590 has a refractive index greater than the gap fill material 580. In some embodiments, the co-packaged optics device 500 can include multiple intermediate waveguide channels 590 and the intermediate waveguide channels 590 do not intersect with each other.

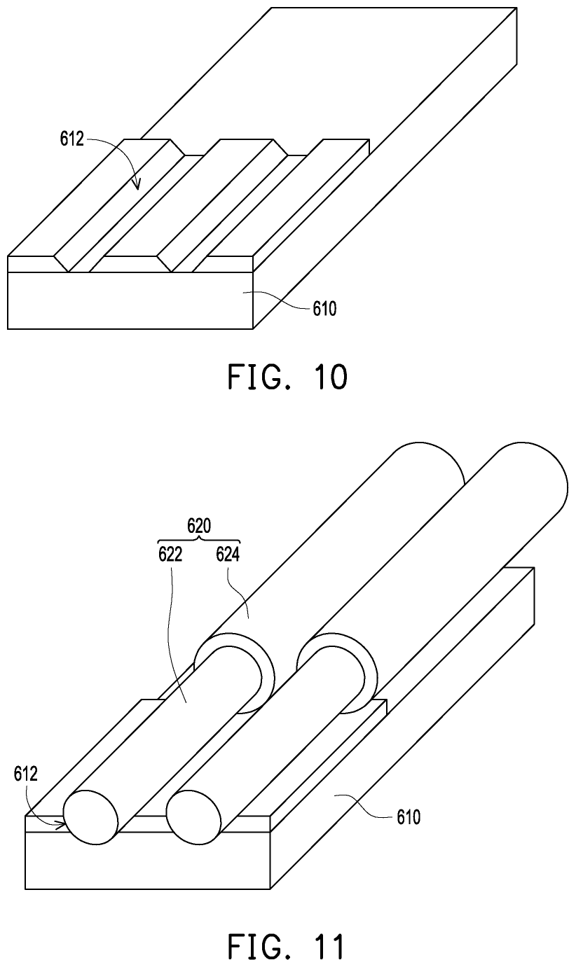

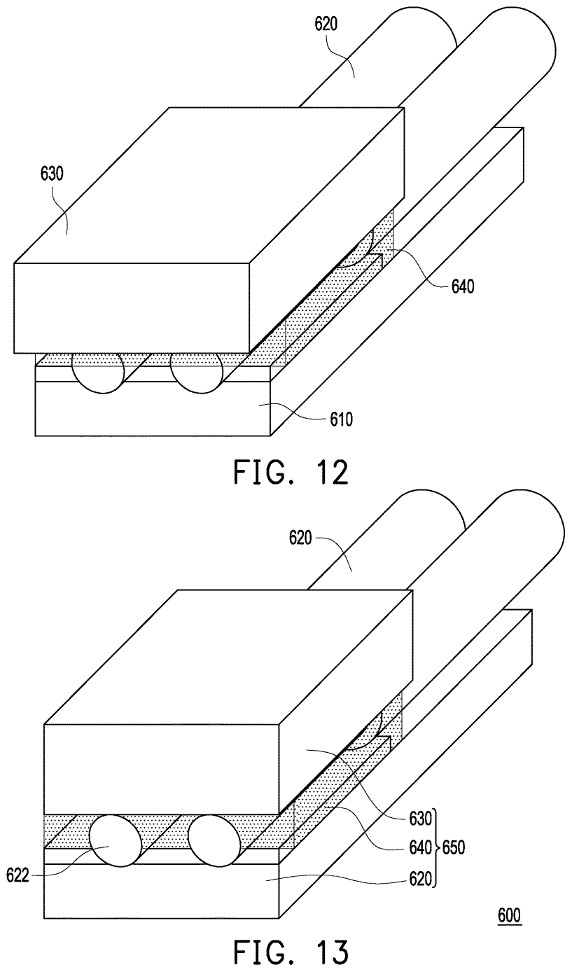

FIG. 10 to FIG. 13 schematically illustrate a fabrication process of a fiber array unit in accordance with some embodiments of the disclosure. In FIG. 10, a pedestal 610 is provided and grooves 612 are formed on the pedestal 610 by a cutting/grinding process. The process of FIG. 11 includes setting the optical fibers 620 on the pedestal 610 and positioning the optical fibers 620 respectively inside the grooves 612. Each of the optical fibers 620 can include a core 622 and a cladding layer 624. The cladding layer 624 at the end portion of each optical fiber 620 is removed and the core at the end portion of each optical fiber 620 is placed on the corresponding groove 612. The process of FIG. 12 includes assembling a cover 630 with the pedestal 610 to sandwich the optical fibers 620 therebetween. In some embodiments, the cover 630 is attached to and assembled with the pedestal 610 through a bonding agent 640. The process of FIG. 13 includes polishing the end surface of the structure so that the core 622 of the optical fiber 620 is substantially flat and smooth to obtain a fiber array unit 600. Specifically, the fiber array unit 600 can include an optical connector 650 assembling multiple optical fibers 620 therein and the optical connector 650 at least includes the pedestal 620 and the cover 630.

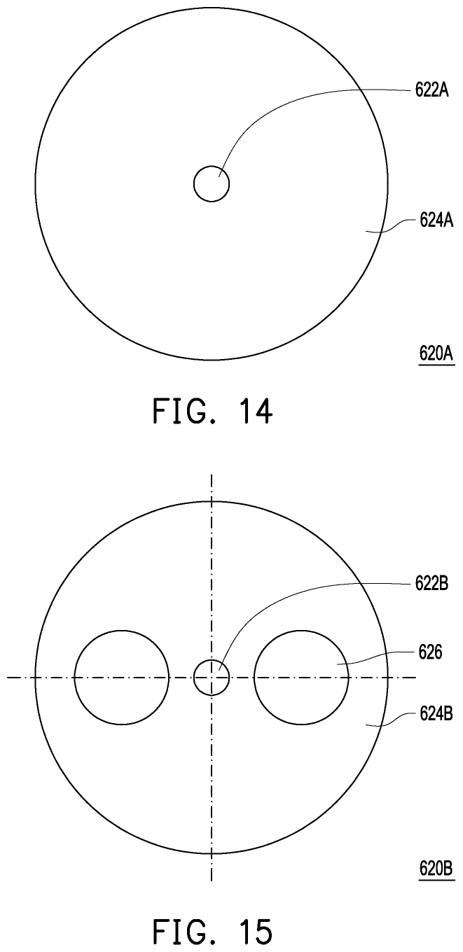

The fiber array unit 600 can be an implemental example of the fiber array unit 200 described in the previous embodiments and thus the description of the embodiment of FIGS. 10 to 13 can be incorporated to the previous embodiments. As described in the previous embodiments, the optical fibers 620 assembled in the fiber array unit 600 have the same configuration. For example, the optical fibers 620 assembled in the fiber array unit 600 are all single mode fibers 620A (as shown in FIG. 14) in some embodiments. The single mode fiber 620A shown in FIG. 14 includes a core 622A and a cladding layer 624A. The single mode fiber 620A involves more flexibility on alignment since the orientation of the core 622A does not limit to a specific orientation, which facilitates the fabrication yield of the fiber array unit 600. In some embodiments, the optical fibers 620 assembled in the fiber array unit 600 are all polarization-maintaining optical fibers (as shown in FIG. 15). The polarization-maintaining optical fiber 620B can include a core 622B, a cladding layer 624B and a pair of stress rods 626. The core 622B and the stress rods 626 are encapsulated by the cladding layer 624B and the core 622B is positioned between the stress rods 626. The polarization-maintaining optical fiber 620B can be assembled in the fiber array unit 600 in a prescribed orientation to maintain a linear polarization during propagation, which requires certain degree of alignment accuracy.

In view of the above, the co-packaged optics device in accordance with some embodiments of the disclosure can include a waveguide component establishing the optical signal transmission paths between the optical transceiver and the fiber array unit. The waveguide channels in the waveguide component allow to intersect with one another and redistribute the transmission paths of the optical signals from the optical fibers assembled by the fiber array unit that is attached to the co-packaged optic device. The opto-electronic module including the co-packaged optics device provides flexible transmission configuration for optical signals.

In some embodiments of the disclosure, a co-packaged optics device can include a package substrate; an electronic component disposed on the package substrate; optical transceivers disposed on the package substrate, arranged around the electronic component, wherein the electronic component is electrically connected to the optical transceivers; and a waveguide component disposed on the package substrate. The waveguide component includes a waveguide bulk having an inward surface facing the optical transceivers and an outward surface opposite to the inward surface; a first waveguide channel embedded in the waveguide bulk and extending from the outward surface to the inward surface; and a second waveguide channel embedded in the waveguide bulk and extending from the outward surface to the inward surface, wherein the first waveguide channel and the second waveguide channel are intersected and directed to different ones of the optical transceivers. The first waveguide channels and the second waveguide channels have a refractive index greater than the waveguide bulk. A gap fill material is disposed between the optical transceivers and the waveguide bulk. An intermediate waveguide channel is surrounded by the gap fill material and extends between one of the first waveguide channel and the second waveguide channel and one of the optical transceivers. The intermediate waveguide channel has a refractive index greater than the gap fill material. A material of the waveguide bulk comprises a transparent material. The electronic component and the optical transceivers are disposed on an interposer substrate and the interposer substrate is bonded onto the package substrate. The waveguide component is adhered onto the package substrate.

In some embodiments of the disclosure, an opto-electronic module can include a co-packaged optics device, a first fiber array unit and a second fiber array unit. The co-packaged optics device includes a package substrate; an electronic component disposed on the package substrate; optical transceivers disposed on the package substrate, arranged around the electronic component, wherein the electronic component is electrically connected to the optical transceivers; and a waveguide component disposed on the package substrate, wherein the waveguide component has an inward surface facing the optical transceivers. The first fiber array unit is attached to the waveguide component. The second fiber array unit is attached to the waveguide component, wherein at least one of optical fibers of the first fiber array unit and at least one of optical fibers of the second fiber array unit communicate to a same one of the optical transceivers through the waveguide component. The optical fibers of the first fiber array unit are polarization-maintaining optical fibers. The optical fibers of the second fiber array unit are single mode optical fibers. The first fiber array unit and the second fiber array unit are detachable from the waveguide component. The co-packaged optics device further includes a gap fill material disposed on the package substrate between the optical transceivers and the inward surface of the waveguide component and intermediate waveguide channels surrounded by the gap fill material and extending between the inward surface of the waveguide bulk and the optical transceivers. The co-packaged optics device further includes an interposer substrate, the electronic component and the optical transceivers are disposed on the interposer substrate and the interposer substrate is bonded onto the package substrate.

In some embodiments of the disclosure, a co-packaged optics device can include a package substrate; an electronic component disposed on the package substrate; optical transceivers disposed on the package substrate, arranged around the electronic component, wherein the electronic component is electrically connected to the optical transceivers; a waveguide bulk disposed on the package substrate; and waveguide channels embedded in the waveguide bulk, wherein inward ends of the waveguide channels directing to the optical transceivers and outward ends of the waveguide channels opposite to the inward ends are arranged in different sequences. Two of the waveguide channels are intersected and directed to different ones of the optical transceivers. Two of the waveguide channels are positioned at different levels above the package substrate. The electronic component and the optical transceivers are disposed on an interposer substrate and the interposer substrate is bonded onto the package substrate. A material of the waveguide bulk is a transparent material. The waveguide channels have a refractive index greater than the waveguide bulk.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An opto-electronic module, comprising:
a co-packaged optics device comprising:
a package substrate;
an electronic component disposed on the package substrate;
optical transceivers disposed on the package substrate, arranged around the electronic component, wherein the electronic component is electrically connected to the optical transceivers; and
a waveguide component disposed on the package substrate, wherein the waveguide component has an inward surface facing and surrounding the optical transceivers along a ring-like path;
a first fiber array unit attached to the waveguide component; and
a second fiber array unit attached to the waveguide component, wherein at least one of optical fibers of the first fiber array unit and at least one of optical fibers of the second fiber array unit communicate to a same one of the optical transceivers through the waveguide component.

2. The opto-electronic module of claim 1, wherein the optical fibers of the first fiber array unit are polarization-maintaining optical fibers.

3. The opto-electronic module of claim 1, wherein the optical fibers of the second fiber array unit are single mode optical fibers.

4. The opto-electronic module of claim 1, wherein the first fiber array unit and the second fiber array unit are detachable from the waveguide component.

5. The opto-electronic module of claim 1, wherein the co-packaged optics device further comprises a gap fill material disposed on the package substrate between the optical transceivers and the inward surface of the waveguide component and intermediate waveguide channels surrounded by the gap fill material and extending between the inward surface of the waveguide component and the optical transceivers.

6. The opto-electronic module of claim 1, wherein the co-packaged optics device further comprises an interposer substrate, the electronic component and the optical transceivers are disposed on the interposer substrate and the interposer substrate is bonded onto the package substrate.

7. Aa co-packaged optics device comprising:
a co-packaged optics device comprising:
a package substrate;
an electronic component disposed on the package substrate;
optical transceivers disposed on the package substrate, arranged around the electronic component, wherein the electronic component is electrically connected to the optical transceivers; and
a waveguide component disposed on the package substrate, wherein the waveguide component extends along a ring-like path to surround the electronic component and the optical transceivers are located between the electronic component and the waveguide component.

8. The co-packaged optics device of claim 7, wherein the waveguide component comprises waveguide channels, and two of the waveguide channels are intersected and directed to different ones of the optical transceivers.

9. The co-packaged optics device of claim 8, wherein the two of the waveguide channels are positioned at different levels above the package substrate.

10. The co-packaged optics device of claim 8, wherein the waveguide channels are arranged in a first pitch at an outward surface of the waveguide component and arranged in a second pitch at an inward surface of the waveguide component, the outward surface is opposite to the inward surface and the first pitch is greater than the second pitch.

11. The co-packaged optics device of claim 7, wherein a material of the waveguide component comprises a transparent material.

12. The co-packaged optics device of claim 7, further comprising an interposer substrate, the waveguide component extends along a periphery of the interposer substrate and the electronic component and the optical transceivers are bonded onto the interposer substrate.

13. The co-packaged optics device of claim 12, wherein the interposer substrate is bonded to the package substrate through bonding components and the waveguide component is adhered onto the package substrate.

14. An opto-electronic module, comprising:
a co-packaged optics device comprising:
a package substrate;
an electronic component disposed on the package substrate;
optical transceivers disposed on the package substrate, arranged around the electronic component, wherein the electronic component is electrically connected to the optical transceivers; and
a waveguide component disposed on the package substrate, wherein the waveguide component comprises first waveguide channels and second waveguide channels, first outward ends of the first waveguide channels are arranged in a smaller pitch than first inward ends of the first waveguide channels, and second outward ends of the second waveguide channels are arranged in a greater pitch then second inward ends of the second waveguide channels;
a first fiber array unit attached to the first outward ends of the first waveguide channels; and
a second fiber array unit attached to the second outward ends of the second waveguide channels.

15. The opto-electronic module of claim 14, wherein the co-packaged optics device further comprises a gap fill material disposed on the package substrate between the optical transceivers and the waveguide component; and intermediate waveguide channels surrounded by the gap fill material and extending between the waveguide component and the optical transceivers.

16. The opto-electronic module of claim 14, wherein the co-packaged optics device further comprises an interposer substrate, the electronic component and the optical transceivers are disposed on the interposer substrate and the interposer substrate is bonded onto the package substrate and laterally surrounded by the waveguide component.

17. The opto-electronic module of claim 14, wherein one of the first inward ends and one of the second inward ends direct to a same one of the optical transceivers.

18. The opto-electronic module of claim 14, wherein the second inward ends direct to a same one of the optical transceivers.

19. The opto-electronic module of claim 14, wherein the first inward ends direct to different ones of the optical transceivers.

20. The opto-electronic module of claim 14, wherein the waveguide component comprises a ring-like bulk and the first waveguide channels and the second waveguide channels are embedded in the ring-like bulk.
